(19) United States
(12) Patent Application Publication
(10) Pub. No.: US 2014/0273914 A1
(43) Pub. Date: Sep. 18, 2014

(54) PANIC MESSAGING IN AN OFDM COMMUNICATION SYSTEM

(71) Applicant: Mobilesphere Holdings II LLC, Kirkland, WA (US)

(72) Inventor: Robert G. Mechaley, Jr., Kirkland, WA (US)

(73) Assignee: Mobilesphere Holdings II LLC, Kirkland, WA (US)

(21) Appl. No.: 14/205,771

(22) Filed: Mar. 12, 2014

Related U.S. Application Data
(60) Provisional application No. 61/781,980, filed on Mar. 14, 2013.

(51) Int. Cl. H04W 4/22; H04W 52/18

(52) U.S. Cl. CPC H04W 4/22; H04W 52/18
USPC 455/404.1

(57) ABSTRACT

A panic button is activated in a wireless communication device to transmit an emergency message. Upon activation, the wireless communication device will monitor one or more predetermined tones in an OFDM system for confirmation that the emergency message has been received. If the emergency message confirmation has not been received, the wireless device can increase the effective transmission level and transmit the emergency message again. The cycle can be repeated where the effective transmission signal strength is repeatedly increased until the confirmation signal is received or until the device reaches its maximum output power. If the message is received, the emergency mode may be deactivated and the repeated transmissions terminated. The device can transmit geo-location data as part of the emergency message and may include an audible alarm activated by the panic button or remotely activated.

### BACKGROUND OF THE INVENTION

1. Field of the Invention

The present disclosure relates generally to orthogonal frequency division multiplex (OFDM) communications and, more particularly, to a technique for panic messaging in an OFDM communication system.

2. Description of the Related Art

Orthogonal frequency division multiplex (OFDM) communication system utilizes a large number of closely-spaced subcarriers to transmit data. The input data is divided into a number of parallel data streams, one for each subcarrier. Each subcarrier is then modulated using a conventional modulation scheme, such as phase shift keying (PSK), quadrature amplitude modulation (QAM), or the like. The subcarriers are orthogonal to each other to prevent intercarrier interference. Those skilled in the art will appreciate that OFDM technology has developed into a popular communication technique for wideband wireless communication.

OFDM communication systems may be used in public service sectors, such as police and fire departments. Known techniques, such as those described in U.S. application Ser. No. 12/695,919 filed Jan. 28, 2010, now U.S. Pat. No. 8,095,163, and U.S. application Ser. No. 12/755,215, filed on Apr. 6, 2010, describe techniques for OFDM communication.

In certain situations, an individual may have a need to transmit an urgent message, or a panic message via the OFDM communication system. It can be appreciated that there is a significant need for techniques that will permit such panic messaging. The present disclosure provides this, and other advantages, as will be apparent from the following detailed description and accompanying figures.

### BRIEF DESCRIPTION OF THE SEVERAL VIEWS OF THE DRAWING(S)

FIG. 1 illustrates an exemplary communication architecture used to implement a communication network in accordance with the present teachings.

FIG. 2 illustrates frequency allocation in an orthogonal frequency division multiplexed system.

FIG. 3 is a functional block diagram of a wireless communication device constructed in accordance with the present teachings.

FIG. 4 is a flowchart illustrating the operation of the system of FIGS. 1 and 2.

### DETAILED DESCRIPTION OF THE INVENTION

As we will be describing in greater detail below, the present disclosure provides a technique for sending a panic message or panic message indicator from a wireless device and listening for a confirmation of the received message. The wireless communication device will listen for the panic message confirmation and increase the transmission signal until receipt of the message is confirmed.

During a call setup process, a set of tones or groups of tones (i.e., subcarrier channels) are assigned to a particular mobile unit. The assignment of tones to a particular mobile unit during a channel set up operation and the actual communication process between a mobile unit and base station is well known in the art and need not be described in greater detail herein. However, a special tone is allocated on the downlink for emergency message confirmation. The wireless communication device initiating the panic message will evaluate that special emergency tone to look for confirmation that the emergency message has been received.

The communication techniques are implemented by a system 100 illustrated in FIG. 1. A base station 102 communicates with a plurality of wireless communication devices 108-114 via wireless communication links 118-124, respectively. Thus, the wireless communication devices 108-114 are all within the coverage area of the base station 102. The wireless communication device 114 is also within the coverage area of a base station 104. The wireless communication device 114 can communicate with the base station 104 via a wireless communication link 126. Also illustrated in FIG. 1 is a wireless communication device 116, which communicates with the base station 104 via a wireless communication link 128. The process of assigning OFDM tones or groups of tones to each of the wireless devices (e.g., the wireless communication device 108) and the actual communication between the wireless communication devices 108-114 and the base station 102 are well-known in the art and need not be described in greater detail herein.

The base station 102 is communicatively coupled to a base station controller 130 via a communication link 132. In a typical embodiment, the base station controller 130 may provide operational control for one or more base stations 102. As illustrated in FIG. 1, the base station 104 is also coupled to the base station controller 130 via a communication link 129. Those skilled in the art will appreciate that a typical wireless communication network will have a large number of base stations that each communicate with a large number of wireless devices. For the sake of clarity, only two base stations (i.e., the base stations 102 and 104) and a few wireless communication devices (i.e., the wireless communication devices 108-116) are illustrated in FIG. 1.

In turn, the base station controller 130 is coupled to a mobile switching center (MSC) 134 via a communication link 136. As is known in the art, the MSC 134 is typically coupled to a large number of base station controllers and is responsible for switching and routing of calls to other base stations and/or a telephone network, such as the public switched telephone network (PSTN) 138.

The MSC 134 may also provide access to a core network 140 via a communication link 142. The core network 140 is the central part of a communication network that may include a number of functions, such as authorization, billing and the like. In addition, the network 140 may provide access to other networks, such as the Internet, for web applications via one or more gateways (not shown).

The MSC 134 is commonly used in circuit-switched networks. For packet-switched networks, a set of equivalent functions may be provided based on TCP/IP and VoIP technologies. The specific form of network elements may vary based on implementation details. However, those skilled in the art will understand that the OFDM implementation of the present teachings may be applicable to a variety of network architectures.

FIG. 1 is simplified to illustrate the operation of the system 100 with a group of wireless communication devices communicating in proximity with each other. In the illustrated embodiment, the wireless communication devices 108-114 are all communicating with the same base station (i.e., the base station 102). However, those skilled in the art will appreciate that the wireless communication devices 108-114 may communicate with other base stations as well. For example, the wireless communication device 114 is capable of communicating with the base station 102 via the wireless communication link 124 or communicating with the base station 104 via the wireless communication link 126. For the sake of simplicity, FIG. 1 also eliminates a number of conventional network elements, such as gateways, firewalls, and other control elements that are not pertinent to a clear understanding of the present teachings.

A plurality of mobile communication devices may be designated for operation in a Group Call function. When individual mobile communication units are designated as part of the same group, the wireless communication devices of that group will all be assigned the same OFDM tones for communication purposes. FIG. 2 illustrates a number of uplink and downlink timeslots and the designation of the tones to various groups. In the example illustrated in FIG. 2, a group of wireless communication devices (e.g., the wireless communication devices 108-110 are designated as Group1. As illustrated in FIG. 2, the wireless communication devices of Group1 are assigned tones 2, 3, and 5 in downlink timeslots 1 and 3. It should be noted that the assigned tones need not be contiguous. Furthermore, the number of tones assigned to a particular group can vary dynamically based on bandwidth requirements for the particular communication application. That is, simple audio communication may require less bandwidth than other forms of data communication, such as streaming video.

Also illustrated in FIG. 2, is a second set of tones assigned to Group2 (e.g., the wireless communication devices 112-116). In this example, the wireless communication devices of Group2 are assigned tones 9 and 10 in downlink time slots 1, 3, 7, 9, and 11. All wireless communication devices that are in a particular sector, cell, or area that identify it as a member of a certain group will receive a Group Call and are assigned the same set of OFDM tones within each timeslot on the downlink (those skilled in the art will appreciate that the downlink is conventionally considered the communication from the base station 102 to the wireless communication devices). Thus, in the example described herein, the wireless communication devices 108-110, which are assigned to Group 1, will all have the same OFDM tones assigned to each mobile unit.

The information for each group is encoded in a conventional fashion using the assigned tones. When the base station transmits the encoded information using the assigned tones for a group, all members in that Call Group will receive the information simultaneously. Thus, the techniques may be used to support a push-to-talk system in an OFDM communication network. Simultaneous receipt of messages can be important in emergency communication situations. For example, a SWAT team going into action can rely on every team member receiving instructions at the same time with the communication system described herein.

The concept illustrated herein is shown in FIG. 2 in a very simplified form with a relatively small number of tones assigned to individual ones of the groups (e.g., Group1, Group2, and Group3). However, a typical OFDM signal contains hundreds or thousands of tones. This advantageously allows a large number of Group Calls to be supported simply by directing the wireless communication devices in each group to receive the appropriate tones or sets of tones assigned to that group. Again, FIG. 2 illustrates a simplistic version with only three groups set up with a relatively small number of tones assigned to each group. However, the principles described herein can be extended to a large number of groups.

FIG. 2 also illustrates the use of a pre-designated emergency (EM) tone in the downlink timeslot. When one of the wireless communication devices (e.g., the wireless communication device 108 in FIG. 1) activates a panic message, that wireless communication device will look for a signal in the EM tone on the downlink. If the emergency message has been received by the base station 102, the base station will send a confirmation by activating the EM tone in each downlink timeslot. In this manner, the wireless communication device 108 can confirm that the emergency message has been received. If the EM tone is not detected by the wireless communication device that activated the panic message (e.g., the wireless communication device 108), it indicates to the wireless communication device 108 that the emergency message has not been received. In that case, the wireless communication device 108 will take additional steps, as described below. Those skilled in the art will appreciate that one or more EM tones may be designated for emergency confirmation signaling.

FIG. 1 illustrates the wireless communication devices (e.g., the wireless communication devices 108-110) in a group (e.g., Group1) as communicating with a single base station. However, the principles of the present disclosure permit group members to be coupled to different base stations. In the example of the SWAT team described above, the actual team members may communicate with a single base station or with multiple base stations if the operational area for the SWAT team is a large geographical area. In addition, a command post, for example, may be established at some distance from the theater of operations. Thus, it is possible that the command post wireless communication device may be in communication with a different base station. In the example of FIG. 1, the wireless communication device 116 may be part of Group1. Even though the wireless communication device 116 communicates with the base station 104, it will receive all communications transmitted to the members of Group1. Those skilled in the art will appreciate that the frequency or subcarrier of the OFDM tones may differ from the base station 102 to the base station 104. That is, the members of Group1 communicating with the base station 102 may be assigned a first set of OFDM tones while the members of Group1 communicating with the second base station may be assigned a second set of OFDM tones that may be the same or different from the first set of OFDM tones. However, the system 100 can identify members of a group communicating with different base stations as members of the same group even though the different base stations may have assigned different set of OFDM tones to the respective wireless communication devices communicating therewith. Similarly, wireless communication devices in a single group may be communicating with the same base station, but with different sectors of that base station. In this fashion, all members of a designated group, whether coupled to the same sector or base station or coupled to different sectors or completely different base stations, can still be configured to simultaneously receive communications from other group members.

FIG. 3 is a functional block diagram of an electronic device, such as the wireless communication devices 108-114 in FIG. 1. The device includes a central processing unit (CPU) 148. Those skilled in the art will appreciate that the CPU 148 may be implemented as a conventional microprocessor, application specific integrated circuit (ASIC), digital signal processor (DSP), programmable gate array (PGA), or the like. The wireless communication device 108 is not limited by the specific form of the CPU 148.

The electronic device in FIG. 3 also contains a memory 150. The memory 150 may store instructions and data to control operation of the CPU 148. The memory 150 may include random access memory, ready-only memory, programmable memory, flash memory, and the like. The electronic device is not limited by any specific form of hardware used to implement the memory 150. The memory 150 may also be integrally formed in whole or in part with the CPU 148.

The electronic device of FIG. 3 also includes conventional components, such as a display 152, keypad or keyboard 154, audio input device 156, and GPS receiver 158. These are conventional components that operate in a known manner and need not be described in greater detail. In many electronic devices, the keyboard 154 is integral with a touch-sensitive display such that individual keys are soft coded into the display 152.

The electronic device of FIG. 3 also includes a transmitter 162 such as may be used by the wireless communication device 108 for normal wireless communication with the base station 102 (see FIG. 1). FIG. 3 also illustrates a receiver 164 that operates in conjunction with the transmitter 162 to communicate with the base station 102. In a typical embodiment, the transmitter 162 and receiver 164 are implemented as an OFDM transceiver 166. The transceiver 166 is connected to an antenna 168. Operation of the transceiver 166 and the antenna 168 is well-known in the art and need not be described in greater detail herein.

The wireless communication device in FIG. 3 also includes an emergency message processor 170, a panic button 172 to activate the emergency message processor 170, and an optional audible alarm 174. The panic button 172 may be part of the keypad 154 or a separate button. When soft-coded as part of the keypad 154, the panic button 174 may occupy a large portion of the display to make activation easier for the user.

The various components illustrated in FIG. 3 are coupled together by a bus system 176. The bus system 176 may include an address bus, data bus, power bus, control bus, and the like. For the sake of convenience, the various busses in FIG. 3 are illustrated as the bus system 176.

The emergency message processor 170 controls the emergency message operation of the electronic device of FIG. 3. Activation of the emergency message processor 170 can occur in a number of ways. For example, the user may activate the panic button 172 to initiate activation of the emergency message processor 170. When the emergency message processor 170 detects activation of the panic button 172, it can send an emergency message to the base station 102. In one example embodiment, the emergency message simply identifies the wireless communication device. Alternatively, the emergency message may include additional information, such as user information, location information, and the like. Location information may be derived using the GPS receiver 158, or through other known location determination technologies, to automatically provide location information. And yet another alternative embodiment, the user may provide location information using text messaging. In this embodiment, the text message may form part of an emergency message transmitted using the emergency message processor 170.

Alternatively, the emergency message processor 170 may be activated by an emergency voice message. In yet another embodiment, the wireless communication device may include a “man-down” sensor to automatically trigger the emergency message processor 170. For example, the man-down sensor may include accelerometers or other devices to monitor the normal orientation of the user in an upright position. If the user falls, the man-down sensor detects the sudden change in orientation and activates the emergency message processor 170. This implementation may be useful in a number of situations. For example, the man-down sensor can be used by emergency personnel (e.g., police officer or firefighter) or may be used by the elderly to automatically activate the emergency message processor 170 if the elderly person falls.

Once the wireless communication device has initiated an emergency message, it will continuously decode the reserved EM tone until such time as it receives a confirmation or acknowledgement of the emergency message it originated. If, after a predetermined time interval, the confirmation message is not received, the wireless communication device can increase the transmit power of the transmitter 162 (see FIG. 1). For example, if the confirmation message is not received within one second, the wireless communication device may double the transmit power of the transmitter 162.

Those skilled in the art will appreciate that the signal from the transmitter 162 can be increased by an actual increase in the output power or by using additional tones on the OFDM uplink. Furthermore, the wireless communication device may increase its effective signal strength by changing the form of modulation. For example, the wireless communication device may change from 64QAM to 16QAM or from 16QAM to PSK.

If the confirmation signal is still not received after a second interval of time, the wireless communication device can again increase its effective transmit power. In one embodiment, the first and second predetermined time intervals may be identical. Alternatively, each successive time interval may be less than the previous time interval. For example, if the first time interval is one second, and the wireless communication device has not received the confirmation signal after one second, it can increase the effective transmit power and attempt to detect the confirmation signal for a shorter time interval, such as 0.5 seconds. If the confirmation signal is not received after the second time interval, the wireless communication can again increase its effective transmit signal. With each successive cycle, the wait period can get shorter and the effective transmit signal strength can be increased. This cycle can continue until the wireless communication device has reached its maximum power output. At that time, it can continuously transmit the emergency signal at the maximum power until the battery dies.

Those skilled in the art will appreciate that the base station (e.g., the base station 102 in FIG. 1) typically provides control signals that adjust the transmitter power of the transmitter 162 (see FIG. 3) or the modulation level used by the wireless communication device. However, in this panic mode of operation, the emergency message processor 170 can override any commands from the base station to thereby increase the effective transmit signal until a confirmation signal is received.

When the confirmation signal is received, the wireless communication device may reset the emergency message processor 170. Alternatively, the emergency processor 170 can remain active at the current effective transmit signal strength when the confirmation message was received. In this embodiment, the continuous transmission of an emergency message may assist in locating the individual requiring assistance. For example, if the firefighter is down inside a burning building, the transmission of signals from the wireless communication device of the fallen firefighter may provide an effective homing signal that allows the firefighter to be located.

In yet another alternative embodiment, an additional one or more OFDM tones may be reserved to activate the audible alarm 174 that is part of the wireless communication device. When the base station 102 transmits the confirmation message using the reserved EM tone, it can also transmit an additional tone that will cause the wireless communication device to activate the audible alarm 174. This may assist emergency personnel in locating the individual requiring assistance. Alternatively, the base station 102 can transmit the alarm command OFDM tone upon request from emergency personnel. For example, when firefighters have reached the approximate location of a fallen firefighter, they can request activation of the audible alarm 174. In this embodiment, the base station transmits the reserved audible alarm OFDM tone. The wireless communication device detects the reserved audible alarm OFDM tone and activates the audible alarm 174 to thereby further assist the firefighters in locating their fallen comrade.

The operation of the system 100 is illustrated in the flow chart of FIG. 4. At step 200 the wireless communication device activates the emergency message processor 170. As described above, there are a number of different techniques by which the emergency message processor 170 can be activated. Once activated, the wireless communication device generates an internal indication that it is operating in an emergency mode. This may be an internal register (e.g., a flag) or other known data indicator. While in the emergency mode, the wireless communication device will repeatedly transmit the emergency message until a confirmation is received, as described above.

In step 202, the wireless communication device transmits an emergency message. A variety of emergency message forms have been described above. In decision 204, the wireless communication device determines whether the emergency confirmation signal (e.g., the EM tone in FIG. 2) has been detected. If the confirmation tone has not been detected, the result of decision 204 is NO and, in decision 206, the wireless communication device determines whether the predetermined time interval has expired. If the time interval has not expired, the result of decision 206 is NO and the wireless communication device returns to decision 204 where it continues to check for the presence of the emergency confirmation tone.

If the confirmation tone is not detected (i.e., the result of decision 204 is NO) and the time interval has expired, the result of decision 206 is YES. In that event, in step 208 the wireless communication device increases the effective transmission signal and, optionally, can also decrease the time interval.

After the execution of step 208, the wireless communication device returns to step 202 and retransmits the emergency message with the increased effective transmission signal strength. The cycle of attempted detection of the emergency confirmation tone detection (i.e., decision 204) and retransmission with increased effective transmission signal is repeated until the wireless communication device reaches its maximum signal strength or until the confirmation tone is detected.

If the confirmation tone (e.g., the EM tone in FIG. 2) is detected, the result of decision 204 is YES. In that event, the wireless communication device may reset the emergency signal in step 210 and, at step 212, terminate the emergency transmissions.

As discussed above, the wireless communication device may also be configured for alternative operation where it may continue to transmit the emergency message at the effective transmission signal strength where the confirmation tone was first detected. In yet another alternative embodiment, the wireless communication device may also detect an additional audible signal activation OFDM tone instructing it to activate the audible alarm 174 within the wireless communication device to further aid in the location of the individual requiring assistance. Thus, the emergency message is transmitted at a higher effective signal level and more frequently until it finally receives confirmation that the emergency message has been received.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A wireless communication device for emergency communication in an OFDM communication system, comprising:
a transmitter configured to transmit data to a base station;
a receiver configured to receive data from the base station;
an emergency activation button operable to initiate emergency communications; and
an emergency message processor to control emergency communications with the base station, the emergency message processor being configured to:
cause the transmitter to transmit an emergency message to the base station, the emergency message including identification data to identify the wireless communication device;
cause the receiver to continuously decode a predetermined emergency OFDM tone to detect an acknowledgement message from the base station indicating that the base station received the emergency message;
if the acknowledgement message is not received within a first predetermined period of time following the transmission of the emergency message, to cause the transmitter to increase the effective signal strength of the transmitter to retransmit the emergency message; and
if the acknowledgement message is not received within a second predetermined period of time following the retransmission of the emergency message, to cause the transmitter to increase the effective signal strength of the transmitter to retransmit the emergency message.

2. The device of claim 1 wherein the transmitter increases the effective signal strength by increasing a transmitter output power.

3. The device of claim 1 wherein the transmitter increases the effective signal strength by altering a modulation type.

4. The device of claim 1 wherein the transmitter increases the effective signal strength by increasing a number of OFDM tones used on the uplink.

5. The device of claim 1 wherein the second predetermined period of time is less than the first predetermined period of time.

6. The device of claim 1 wherein the emergency activation button is a user-operable panic button separate from a keyboard.

7. The device of claim 1 wherein the emergency activation button is a user-operable panic button integral with a touch-sensitive display.

8. The device of claim 1, further comprising a sensor to detect a change of orientation of a user of the device wherein the emergency activation button is automatically activated by the change in orientation detected by the sensor.

9. The device of claim 1, further comprising an audible alarm that is activated in response to activation of the emergency activation button.

10. The device of claim 1, further comprising a remotely activated audible alarm, the emergency message processor being further configured to cause the receiver to decode a predetermined alarm activation OFDM tone to detect an alarm activation command from the base station wherein the audible alarm is activated in response to the receiver detecting the alarm activation command from the base station.

11. The device of claim 1, further comprising a position determination receiver to generate geo-location data and the transmitter transmits the geo-location data as part of the emergency message.

12. A system for emergency communication in an OFDM communication system having a base station, comprising:
a plurality of OFDM wireless communication devices each configured to receive call set-up commands from the base station to assign each of the plurality of wireless communication devices a respective set of tones for use on an uplink and a respective set of tones for use on a downlink;
each of the wireless communication devices having a transmitter configured to transmit data to the base station on the uplink using the set of tones assigned for use on the uplink;
each of the wireless communication devices having a receiver configured to receive data from the base station on the downlink using the set of tones assigned for use on the downlink;
each of the wireless communication devices having an emergency activation button operable to initiate emergency communications; and
each of the wireless communication devices having an emergency message processor to control emergency communications with the base station, the emergency message processor for a selected one of the plurality of wireless communication devices whose emergency activation button has been activated being configured to:
cause the transmitter of the selected wireless communication device to transmit an emergency message to the base station, the emergency message including identification data to identify the selected wireless communication device;
cause the receiver of the selected wireless communication device to continuously decode a predetermined emergency OFDM tone to detect an acknowledgement message from the base station indicating that the base station received the emergency message;
if the acknowledgement message is not received within a first predetermined period of time following the transmission of the emergency message, to cause the transmitter of the selected wireless communication device to increase the effective signal strength of the transmitter to retransmit the emergency message regardless of any power control commands received from the base station; and
if the acknowledgement message is not received within a second predetermined period of time following the retransmission of the emergency message, to cause the transmitter of the selected wireless communication device to increase the effective signal strength of the transmitter to retransmit the emergency message.

13. The system of claim 12 wherein each of the plurality of wireless communication devices is assigned the same set of tones for use on the downlink whereby each of the plurality of wireless communication devices receives the same communication data on the downlink as a Group Call function.

14. The system of claim 12 wherein the transmitter of the selected wireless communication device increases the effective signal strength by increasing a transmitter output power.

15. The system of claim 12 wherein the transmitter of the selected wireless communication device increases the effective signal strength by altering a modulation type.

16. The system of claim 12 wherein the transmitter of the selected wireless communication device increases the effective signal strength by increasing a number of OFDM tones used on the uplink.

17. The system of claim 12 wherein the second predetermined period of time is less than the first predetermined period of time.

18. The system of claim 12, further comprising an audible alarm in the selected wireless communication device that is activated in response to activation of the emergency activation button.

19. The system of claim 12, further comprising a remotely activated audible alarm in the selected wireless communication device, the emergency message processor of the selected wireless communication device being further configured to cause the receiver of the selected wireless communication device to decode a predetermined alarm activation OFDM tone to detect an alarm activation command from the base station wherein the audible alarm is activated in response to the receiver detecting the alarm activation command from the base station.

20. A method for emergency communication by a wireless communication device in an OFDM communication system, comprising:
sensing activation of an emergency activation button to initiate emergency communications;
using a transmitter to transmit an emergency message to a base station, the emergency message including identification data to identify the wireless communication device;
using a receiver to continuously decode a predetermined emergency OFDM tone to detect an acknowledgement message from the base station indicating that the base station received the emergency message;
if the acknowledgement message is not received within a first predetermined period of time following the transmission of the emergency message, increasing the effective signal strength of the transmitter to retransmit the emergency message; and
if the acknowledgement message is not received within a second predetermined period of time following the retransmission of the emergency message, increasing the effective signal strength of the transmitter to retransmit the emergency message.

21. The method of claim 20 increasing the effective signal strength comprises increasing a transmitter output power.

22. The method of claim 20 increasing the effective signal strength comprises altering a modulation type.

23. The method of claim 20 wherein the transmitter increases the effective signal strength by increasing a number of OFDM tones used on the uplink.

24. The method of claim 20, further comprising detecting a change of body orientation of a user of the device wherein the emergency activation button is automatically activated by the detected change in orientation.

25. The method of claim 20, further comprising activating an audible alarm in response to activation of the emergency activation button.

26. The method of claim 20, further comprising using the receiver to decode a predetermined alarm activation OFDM tone to detect an alarm activation command from the base station and activating an audible alarm in response to the receiver detecting the alarm activation command from the base station.

27. The method of claim 20, further comprising generating geo-location data and transmitting the geo-location data as part of the emergency message.
